(19) United States
(12) Patent Application Publication
(10) Pub. No.: US 2019/0114801 A1
(43) Pub. Date: Apr. 18, 2019

(54) INTERACTIVE INTERFACE SYSTEM, WORK ASSISTANCE SYSTEM, KITCHEN ASSISTANCE SYSTEM, AND INTERACTIVE INTERFACE SYSTEM CALIBRATION METHOD

(71) Applicant: PANASONIC INTELLECTUAL PROPERTY MANAGEMENT CO., LTD., Osaka (JP)

(72) Inventors: Yuusaku SHIMAOKA, Osaka (JP); Takayuki MOHRI, Tokyo (JP)

(21) Appl. No.: 16/164,398

(22) Filed: Oct. 18, 2018

(30) Foreign Application Priority Data
Oct. 18, 2017 (JP) 2017-202077

(51) Int. Cl. G06T 7/73; G06T 7/80; G09G 3/00; G06F 3/042

(52) U.S. Cl. CPC G06T 7/73; G06T 7/80; G09G 3/002; G06T 7/521; G06T 2207/30204; G06T 2207/10048; G06T 2207/10024; G06F 3/0425

(57) ABSTRACT

An interactive interface system includes: a display device configured to display a picture on a display screen; and a sensor device configured to detect a position of a detection target. The interactive interface system further includes a calibration mode. The calibration mode is a mode of performing calibration between a display position on the display screen and a detection position by the sensor device, based on a detection result which is given by the sensor device and indicates a detected position of a marker present within the display screen.

### CROSS-REFERENCE TO RELATED APPLICATION

The present application is based upon and claims the benefit of priority of Japanese Patent Application No. 2017-202077, filed on Oct. 18, 2017, the entire contents of which are incorporated herein by reference.

### TECHNICAL FIELD

The present disclosure relates to interactive interface systems, work assistance systems, kitchen assistance systems, and interactive interface system calibration methods, and particularly to an interactive interface system including a display device, a work assistance system, a kitchen assistance system, and an interactive interface system calibration method.

### BACKGROUND ART

JP 2012-173447 A (hereinafter referred to as “document 1”) discloses an interactive system including a projector, a light emitting pen, and a position information converter. The projector projects a picture onto a projection surface. The light emitting pen includes a push switch and a light emitting diode at its top end of a body with a pen shape. When a user presses the top end of the light emitting pen against a projection screen, the push switch is pushed and then the light emitting diode emits light. The position information converter includes an imaging unit for taking an image of an area including a projection image projected onto the projection screen. The position information converter determines, based on an imaging image from the imaging unit, whether or not the light emitting pen emits light in the imaging image. When emission of light occurs, the position information converter detects position information (coordinates) of a position where emission of light occurs.

In the interactive system of document 1, calibration is performed to associate positions of the projection image projected from the projector and the imaging image. In implementing the calibration, the projector projects an image showing a calibration point. When the user presses the top end of the light emitting pen against a center of the calibration point, the light emitting pen emits light, and the position information converter detects position information of a position where the light is emitted. The position information converter performs the calibration for each of the plurality of calibration points, thereby associating the positions between the projection image projected from the projector and the imaging image.

In the interactive system of document 1, in implementing the calibration, the user holds the light emitting pen and presses the top end of the light emitting pen against the center of the calibration point. Therefore, there may be probabilities that an image from the imaging unit shows a body such as hands and arms of the user holding the light emitting pen or user's shadow, light reflected from the body or clothes of the user, and the like. This may cause reduction of accuracy of the calibration.

### SUMMARY

An object of the present disclosure would be to propose an interactive interface system, a work assistance system, a kitchen assistance system, and an interactive interface system calibration method which are capable of improving accuracy of calibration.

An interactive interface system of one aspect according to the present disclosure includes: a display device configured to display a picture on a display screen; and a sensor device configured to detect a position of a detection target. The interactive interface system further includes a calibration mode of performing calibration between a display position on the display screen and a detection position by the sensor device, based on a detection result which is given by the sensor device and indicates a detected position of a marker present within the display screen.

A work assistance system of one aspect according to the present disclosure includes the interactive interface system of the above. The display device is configured to display an item for assisting work on the display screen.

A kitchen assistance system of one aspect according to the present disclosure includes the interactive interface system of the above. The display device is configured to display an item for assisting cooking work in a kitchen on the display screen.

An interactive interface system calibration method of one aspect according to the present disclosure includes: a displaying step; and an adjusting step. The displaying step is a step of displaying, by a display device, a picture on a display screen. The detection step is a step of detecting, by a sensor device, a position of a marker present within the display screen. The adjusting step is a step of performing calibration between a display position on the display screen and a detection position by the sensor device, based on a detection result given by the sensor device.

### BRIEF DESCRIPTION OF THE DRAWINGS

FIG. 1 is a block diagram of an interactive interface system of one embodiment according to the present disclosure.

FIG. 2 is a perspective view of a cooking counter where the interactive interface system of the above is applied.

FIG. 3 is a side view of the cooking counter where the interactive interface system of the above is applied.

FIG. 4 is a flow chart for illustration of calibration operation of the interactive interface system of the above.

FIG. 5 is an explanatory illustration of an adjustment image projected by the interactive interface system of the above.

FIG. 6 is a perspective view of a three-dimensional marker used in calibration of the interactive interface system of the above.

FIG. 7 is an explanatory illustration of a scene where the three-dimensional markers are arranged in the calibration of the interactive interface system of the above.

FIG. 8 is an explanatory illustration of a scene where the three-dimensional markers are arranged in the calibration of the interactive interface system of the above, when viewed diagonally from the front.

FIG. 9 is an explanatory illustration of a cooking instruction screen displayed by a kitchen assistance system including the interactive interface system of the above.

FIG. 10 is an explanatory illustration of a scene where the three-dimensional markers are arranged in calibration of an interactive interface system of a variation of the embodiment according to the present disclosure.

### DETAILED DESCRIPTION

### Embodiments

(1) Outline

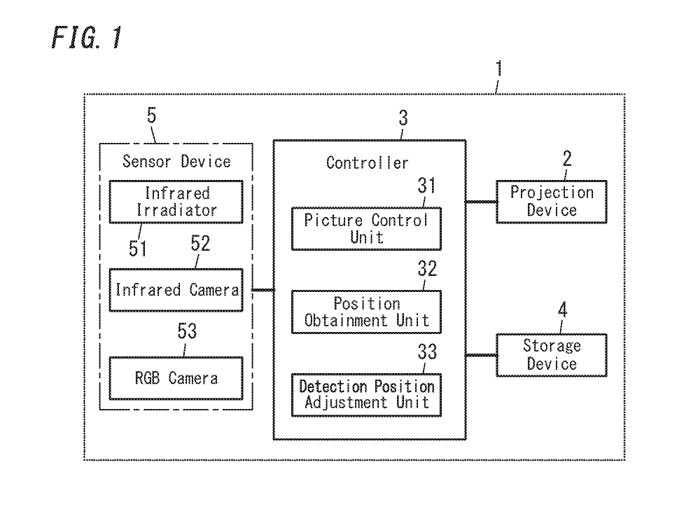

As shown in FIG. 1, an interactive interface system 1 of the present embodiment includes a display device (a projection device 2) and a sensor device 5.

The display device (the projection device 2) is configured to display a picture on a display screen. In this regard, the “display screen” means a display surface where one or more display items are displayed. When the display device includes the projection device 2, the display screen is a screen onto which a picture is projected from the projection device 2 (in the present embodiment, a work surface 101). Note that, the display device includes a display such as a liquid crystal display, the display screen is a screen of the display.

The sensor device 5 is configured to detect a position of a detection target.

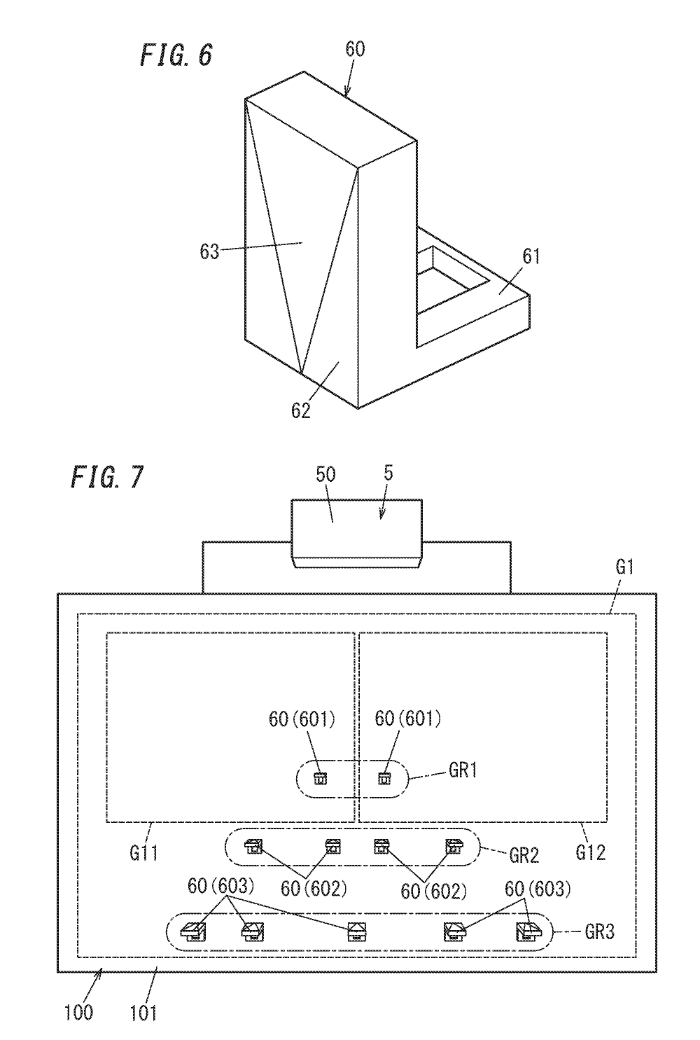

The interactive interface system 1 has a calibration mode. The calibration mode is a mode of performing calibration between a display position on the display screen and a detection position of the sensor device 5, based on a detection result which is given by the sensor device 5 and indicates a detected position of a marker present within the display screen. In this regard, the “marker present within the display screen” means a marker which is present in the display screen when viewed from the sensor device 5, and includes a marker placed at a position overlapping the display screen while it is contact with the display screen or is apart from the display screen, and a marker present in an area of the display screen. The “marker” may be a tangible marker or an intangible marker as long as it can be detected by the sensor device 5. Examples of the “marker” may include three-dimensional markers 60 (see FIG. 6 and FIG. 7) placed at predetermined places overlapping the display screen for the display device (the projection device 2). Note that, the predetermined place overlapping the display screen may include positions in contact with the display screen or positions apart from the display screen. When the sensor device 5 is an image sensor, examples of the “marker” may include a light source for emitting light, a reflective member for reflecting light, a diffusing member for diffusing light, and a bright spot displayed on the display screen.

As described above, the calibration mode preforms calibration between the display position on the display screen and the detection position of the marker detected by the sensor device 5. Accordingly, a user is not required to stay in a vicinity of a position of the marker or a vicinity of the display position. Thus, the calibration can be conducted in a condition where a body or clothes of the user does not present near the position of the marker or the display position. Consequently, the body or clothes of the user can be suppressed from influencing on the calibration result and thus the accuracy of the calibration can be improved.

(2) Details

Hereinafter, the interactive interface system 1 of the present embodiment is described with reference to drawings attached. The interactive interface system 1 described below may be used as a human machine interface of a kitchen assistance system, for example. The kitchen assistance system may be installed in a kitchen such as a cooking place of a fast-food restaurant, and assists cooking work to be performed by a user (a worker of such cooking work), for example.

(2.1) Configurations

As shown in FIG. 1, the interactive interface system 1 of the present embodiment includes a projection device 2, a controller 3, a storage device 4, and a sensor device 5.

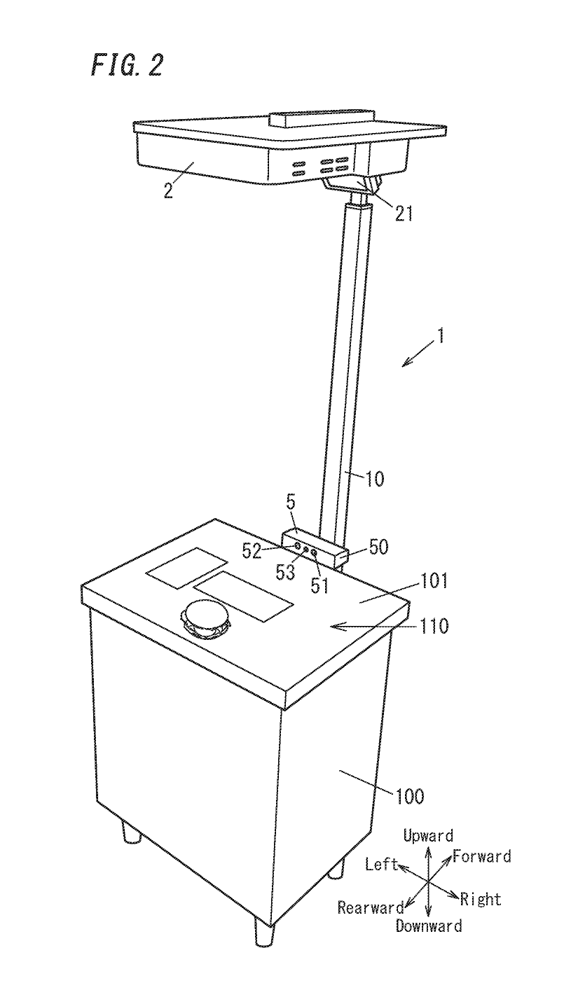

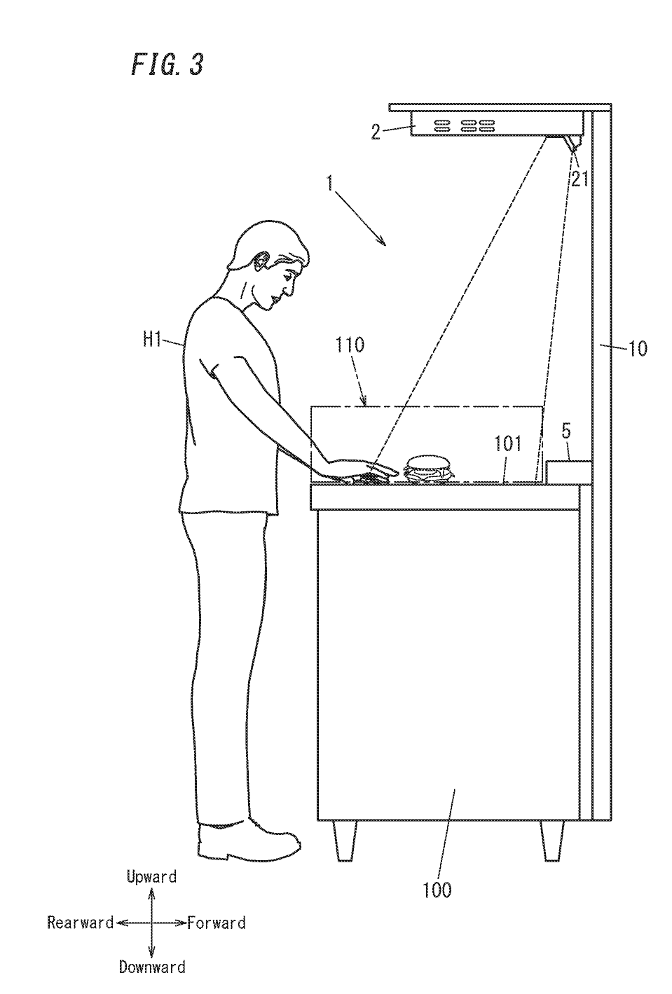

As shown in FIG. 2 and FIG. 3, the interactive interface system 1 is provided to a cooking counter 100 where a worker H1 prepares a food ordered by a customer. In the following, directions in FIG. 2 and the like are defined by “upward”, “downward”, “left”, “right”, “forward”, and “rearward” arrows. In other words, upward, downward, left, right, forward, and rearward directions are defined based on directions when the worker H1 performing cooking looks at the work area 110 (a work surface 101 which is an upper surface of the cooking counter 100, and a space above it). However, these defined directions do not give any limitation on directions of the interactive interface system 1 in use.

The projection device 2 is supported on a pillar 10 placed in front of the cooking counter 100 to be positioned above the cooking counter 100, for example. The projection device 2 of the present embodiment includes a display such as a projector, and a mirror 21 reflecting a picture output from the display and projecting it, for example. The projection device 2 projects a picture toward the work area 110, that is, onto the work surface 101 of the cooking counter 100. Note that, the projection device 2 makes the mirror 21 reflect a picture output, thereby projecting the picture onto the upper surface (the work surface 101) of the cooking counter 100. However, the projection device 2 may project a picture onto the work surface 101 of the cooking counter 100 directly. Alternatively, the projection device 2 may be provided integrally to the cooking counter 100.

The storage device 4 includes a storage device such as a hard disc drive, a memory card, and the like. The storage device 4 may store image data for projection onto the display screen (the work surface 101) by the projection device 2, one or more programs to be executed by a computer system of the controller 3 described below, and the like. The image data may include image data of cooking instruction screens for indicating cooking procedure for the worker H1, for example.

The sensor device 5 includes an infrared irradiator 51, an infrared camera 52, and an RGB camera 53. A case 50 of the sensor device 5 is placed near a front end of the work surface 101 of the cooking counter 100. In other words, the sensor device 5 is placed in one direction when viewed from the work surface 101 serving as the display screen, and is placed close to one side of the display screen (the work surface 101) (in the present embodiment, a front side). In the present embodiment, the sensor device 5 is not placed to entirely surround the display screen, but a position of an object overlapping the display screen is detected by use of the sensor device 5 placed in one direction when viewed from the display screen.

The infrared irradiator 51, the infrared camera 52, and the RGB camera 53 are arranged in a front surface (a surface close to the work area 110) of the case 50 (see FIG. 2). The infrared irradiator 51 emits infrared light toward the work area 110 in a direction across the upward and downward directions (directions perpendicular to the work surface 101 serving as the display screen) (in the present embodiment, the forward and rearward directions perpendicular to the upward and downward directions). The sensor device 5 includes the infrared camera 52 and the RGB camera 53 which serve as an image sensor. The infrared camera 52 and the RGB camera 53 take an image of the work area 110 in a direction across the upward and downward directions (in the present embodiment, the forward and rearward directions perpendicular to the upward and downward directions).

The RGB camera 53 includes an imaging element such as a CCD image sensor and a CMOS image sensor, for example. The RGB camera 53 takes a two-dimensional image (color image) of the work area 110 at a predetermined frame rate (e.g., 10 to 80 frames per sec), for example.

The infrared irradiator 51 and the infrared camera 52 form a distance image sensor measuring a distance by a TOF (Time of Flight) method, for example. The infrared irradiator 51 emits infrared light toward the work area 110. The infrared camera 52 includes a light receiving element with sensitivity for infrared light such as a CMOS image sensor and a CCD image sensor, and thereby receives infrared light. The infrared camera 52 and the RGB camera 53 are arranged in the case 50 to face in the same direction. The infrared camera 52 receives light which is emitted from the infrared irradiator 51 and then reflected from an object (e.g., foodstuffs, cooking instruments, hands of the worker H1, or the like) present in the work area 110. The distance image sensor can measure a distance to an object based on time from emission of infrared light from the infrared irradiator 51 to reception of the infrared light by the infrared camera 52.

Thus, the sensor device 5 outputs the two-dimensional image taken by the RGB camera 53 and a distance image output from the infrared camera 52, to the controller 3. In this regard, the distance image is defined as a grayscale image representing distances to objects by gray shades. Further, since the infrared camera 52 and the RGB camera 53 take images of the work area 110 in directions across the upward and downward directions, the sensor device 5 can detect a position in height (upward and downward direction) of an object present in the work area 110. Accordingly, the controller 3 can determine whether an object is in contact with the display screen (the work surface 101), based on the two-dimensional image and the distance image input from the sensor device 5.

Note that, in the present embodiment, the infrared irradiator 51, the infrared camera 52, and the RGB camera 53, of the sensor device 5 are housed in the single case 50. Alternatively, the infrared irradiator 51, the infrared camera 52, and the RGB camera 53 may be distributedly arranged in two or more cases.

The controller 3 includes functions of a picture control unit 31, a position obtainment unit 32, and a detection position adjustment unit 33.

The controller 3 includes a computer system including one or more processors and one or more memories. The one or more processors of the computer system execute one or more programs stored in the one or more memories of the computer system or the storage device 4, thereby realizing functions of the controller 3. The one or more programs executed by the one or more processors of the computer system may be stored in the one or more memories or the storage device 4 in advance, or may be supplied through telecommunications circuits such as the Internet, or may be provided with they being recorded in a non-transitive recording medium such as memory cards.

The picture control unit 31 is configured to control operation in which the projection device 2 projects a picture toward the work area 110. The picture control unit 31 orders the projection device 2 to project a picture such as a food related picture related to cooking work performed by the worker H1. The food related picture may include a cooking instruction screen indicating work procedure for each step in the cooking work including a plurality of step. The picture control unit 31 controls the projection device 2 to project a picture such as the cooking instruction screen toward the work area 110.

The position obtainment unit 32 is configured to obtain a position of an object overlapping the work surface 101 (a surface onto which a picture is projected by the projection device 2) of the cooking counter 100, based on the two-dimensional image and the distance image inputted from the sensor device 5. In more detail, the position obtainment unit 32 detects an object from the two-dimensional image by performing template matching, and determines a position of the object in the two-dimensional image, for example. Additionally, the position obtainment unit 32 is configured to determine a distance from the sensor device 5 to the object, based on the position of the object in the two-dimensional image and the distance image. Further, the position obtainment unit 32 is configured to determine a position of the object in the work surface 101 serving as the display screen, based on the position of the object in the two-dimensional image and the distance from the sensor device 5 to the object. In this regard, when detecting a plurality of objects from the two-dimensional image, the position obtainment unit 32 may determine a position of an object in the work surface 101 for each of the plurality of objects.

The detection position adjustment unit 33 is configured to, in a calibration mode, perform calibration between the display position on the display screen and the detection position by the sensor device 5, based on the detection position of the three-dimensional marker 60 obtained by the position obtainment unit 32 from the sensor device 5. The three-dimensional marker 60 is placed at a predetermined place overlapping the display screen in the calibration mode. The detection position adjustment unit 33 determines correction information for correcting the detection result of the sensor device 5 and stores the correction information in the storage device 4.

The controller 3 is configured to, after end of the calibration mode, correct the detection result of the position of the object obtained by the position obtainment unit 32 by use of the correction information stored in the storage device 4 to determine the correct position of the object.

In the present embodiment, as shown in FIG. 6, the three-dimensional marker 60 used in the calibration mode includes a pedestal 61 with a rectangular plate shape to be placed on the work surface 101 of the cooking counter 100, and a display part 62 with a rectangular plate shape extending upward from one end in a length of the pedestal 61. There is an inverted triangle mark 63 provided to a surface of the display part 62 by appropriate methods such as printing, painting, or using tape. The mark 63 is an isosceles triangle with one side defined as an upper side of the display part 62 and a vertex defined as a midpoint of a lower side of the display part 62. The mark 63 provided to the display part 62 has a lower end which indicates a contact point with the display screen (the work surface 101). Note that, shapes of the three-dimensional marker 60 and the mark 63 may be modified appropriately. For example, the three-dimensional marker 60 may have a shape of a pillar such as a square prism and a triangular prism, or a shape of a pyramid shape such as a three-sided pyramid and a four-sided pyramid.

(2.2) Operation

Operation of the interactive interface system 1 of the present embodiment is described.

(2.2.1) Explanation of Operation in Calibration Mode

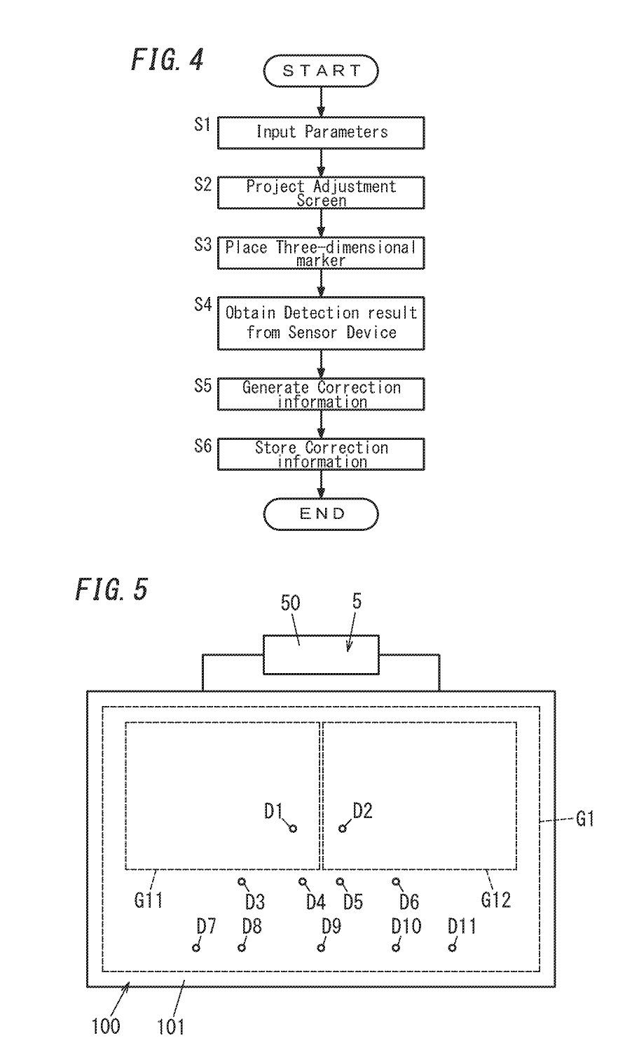

The controller 3 of the interactive interface system 1 performs calibration operation at an appropriate timing or in response to reception of manual operation input from the worker H1. Hereinafter, the calibration operation performed by the controller 3 is described with reference to a flow chart shown in FIG. 4.

The picture control unit 31 of the controller 3 generates image data of an input screen for allowing input of parameters used in the calibration, and outputs it to the projection device 2. When receiving the image data of the input screen from the picture control unit 31, the projection device 2 projects the input screen onto the work surface 101 of the cooking counter 100. Examples of the parameters may include a size of a picture projected onto the work surface 101 by the projection device 2, a distance between the sensor device 5 and a screen projected by the projection device 2 (e.g., a front side of the screen), and a displacement between a center position of the sensor device 5 and a center position of the screen in a lateral direction.

When the worker H1 inputs the parameters by use of an input device such as a keyboard in a condition where the input screen is projected onto the work surface 101 (S1 in FIG. 4), the controller 3 stores the parameters inputted, in the storage device 4. Note that, input of the parameters may be done in advance.

After end of input of the parameters, the picture control unit 31 of the controller 3 generates image data of an adjustment screen G1 (see FIG. 5) and outputs it to the projection device 2. The adjustment screen G1 includes a picture showing a plurality of (eleven, in an example shown in FIG. 5) circular dots D1 to D11 indicating positions where a plurality of three-dimensional markers 60 (see FIG. 6) are to be placed, respectively. Note that, shapes of the dots D1 to D11 may not be limited to such circular shapes. Shapes of marks which are shown in the adjustment screen G1 and indicate the positions where three-dimensional markers 60 (see FIG. 6) are to be placed may be modified appropriately.

In the present embodiment, the adjustment screen G1 includes a display area G11 showing the two-dimensional image from the RGB camera 53 and a display area G12 showing a synthesis image of the two-dimensional image from the RGB camera 53 and the distance image from the infrared camera 52. Note that, it is not necessary for the adjustment screen G1 to include the display areas G11 and G12, but the display areas G11 and G12 may be omitted.

When receiving the image data of the adjustment screen G1 from the picture control unit 31, the projection device 2 projects the adjustment screen G1 onto the work surface 101 of the cooking counter 100 (S2 in FIG. 4).

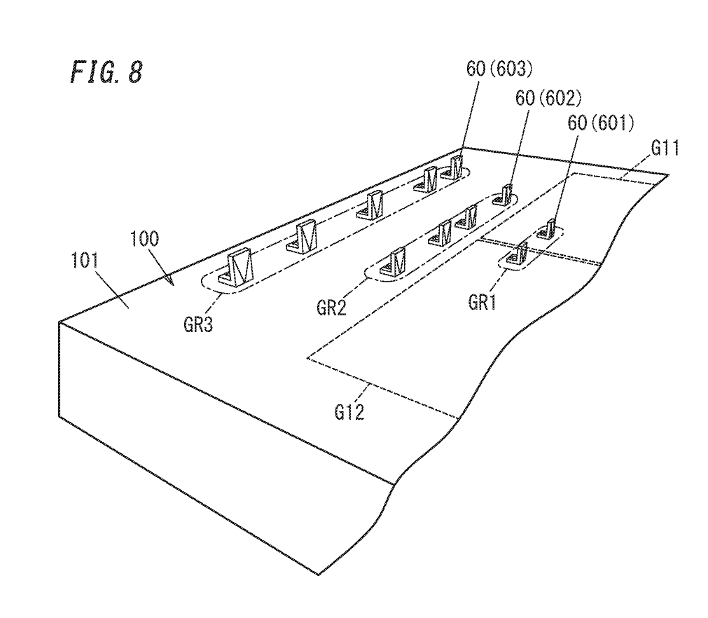

After the adjustment screen G1 is displayed on the work surface 101 of the cooking counter 100, the worker H1 arranges the plurality of three-dimensional markers 60 on the plurality of dots D1 to D11 respectively, as shown in FIG. 7 and FIG. 8 (S3 in FIG. 4). In this regard, each of the plurality of three-dimensional markers 60 is arranged to make its display part 62 face the sensor device 5.

After a lapse of predetermined time from projection of the adjustment screen G1 by the projection device 2, the position obtainment unit 32 of the controller 3 obtains from the sensor device 5 the two-dimensional image and the distance image which represent the work area 110, as the detection result (S4 in FIG. 4). Note that, when the controller 3 receives manual operation input inputted by the worker H1 by use of an appropriate method after the projection device 2 projects the adjustment screen G1, the position obtainment unit 32 of the controller 3 may obtain the two-dimensional image and the distance image which represent the work area 110, from the sensor device 5.

The position obtainment unit 32 detects the marks 63 of the plurality of three-dimensional markers 60 from the two-dimensional image by the template matching, for example, and determines a position (a position in the two-dimensional image) of the lower end of the mark 63 for each of the plurality of three-dimensional markers 60. Additionally, for each of the plurality of three-dimensional markers 60 detected from the two-dimensional image, the position obtainment unit 32 determines a distance from the sensor device 5 to the lower end of the mark 63 from the distance image. After that, for each of the plurality of three-dimensional markers 60, the position obtainment unit 32 determines a position of the lower end of the mark 63 in the work surface 101 serving as the display screen, by use of the position of the lower end of the mark 63 in the two-dimensional image and the distance from the sensor device 5 to the lower end of the mark 63. Consequently, the position obtainment unit 32 can obtain positions (positions in the work surface 101) of the plurality of three-dimensional markers 60 placed on the dots D1 to D11 in the adjustment screen G1, based on the detection result of the sensor device 5.

In this regard, the position obtainment unit 32 obtains the position of the lower end of the mark 63 provided to the display part 62 of the three-dimensional marker 60 (a contact point with the display screen) as the position of the three-dimensional marker 60. Therefore, by placing each of the plurality of three-dimensional markers 60 so that the lower end of the mark 63 is positioned at a position of a corresponding dot of the plurality of dots D1 to D11, it is possible to set the detection positions of the plurality of three-dimensional markers 60 to the positions of the corresponding dots D1 to D11.

As described above, when the position obtainment unit 32 obtains the detection positions of the plurality of three-dimensional markers 60, the detection position adjustment unit 33 determines the correction information based on the positions of the dots D1 to D11 in the adjustment screen G1 and the detection positions of the three-dimensional markers 60 placed on the dots D1 to D11 (S5 in FIG. 4). The correction information is defined as position conversion information for converting the detection position (in the present embodiment, the contact point with the display screen) of the three-dimensional marker 60 placed on a calculation target dot selected from the dots D1 to D11, into a position in the adjustment screen G1 of the calculation target dot. In summary, the sensor device 5 of the present embodiment can detect the contact point between the three-dimensional marker 60 and the display screen from the position of the lower end of the mark 63, and therefore calibration between the display position on the display screen and the contact point can be performed. When determining the correction information for each position of the dots D1 to D11, the detection position adjustment unit 33 stores the correction information (position conversion information) determined for each position of the dots D1 to D11 in the storage device 4 (S6 in FIG. 4), and then ends the calibration mode.

In the present embodiment, the plurality of dots D1 to D11 are set to positions so that the plurality of three-dimensional markers 60 placed on the dots D1 to D11 do not overlap with each other when viewed from the sensor device 5. Accordingly, when the sensor device 5 takes the two-dimensional image and the distance image, of the work area 110, all the plurality of three-dimensional marker 60 are represented in the two-dimensional image and the distance image taken by the sensor device 5. Therefore, it is possible to detect the positions of the plurality of three-dimensional marker 60 at one time. Note that, it may be sufficient that the wholes of the plurality of three-dimensional markers 60 placed on the dots D1 to D11 are not overlapped with each other when viewed from the sensor device 5. It may be sufficient that at least parts of the three-dimensional markers 60 (the lower ends of the marks 63 each defined as a part including a vertex) are not overlapped with each other.

Additionally, as shown in FIG. 7 and FIG. 8, the plurality of three-dimensional markers 60 placed on the dots D1 to D11 are classified into three groups GR1, GR2, and GR3 according to distances from the sensor device 5. The distances from the sensor device 5 to the three-dimensional markers 60 (601) belonging to the group GR1 are shorter than the distances from the sensor device 5 to the three-dimensional markers 60 (602) belonging to the group GR2. The distances from the sensor device 5 to the three-dimensional markers 60 (603) belonging to the group GR3 are longer than the distances from the sensor device 5 to the three-dimensional markers 60 (602) belonging to the group GR2. Further, the sizes of the front surfaces (the display parts 62) of the three-dimensional markers 60 (601) belonging to the group GR1 are smaller than the sizes of the front surfaces (the display parts 62) of the three-dimensional markers 60 (602) belonging to the group GR2. Additionally, the sizes of the front surfaces of the three-dimensional markers 60 (603) belonging to the group GR3 are larger than sizes of the front surfaces of the three-dimensional markers 60 (602) belonging to the group GR2.

As described above, as to the three-dimensional markers 601, 602, and 603 respectively belonging to the groups GR1, GR2, and GR3, a three-dimensional marker 60 in a group with a relatively long distance from the sensor device 5 has a larger front surface than a three-dimensional marker 60 in a group with a relatively short distance from the sensor device 5. In summary, the plurality of three-dimensional markers 60 include two or more three-dimensional markers 60 which are placed at different distances from the sensor device 5 and have mutually different actual (real) sizes to reduce an apparent dimensional difference therebetween when viewed from the sensor device 5.

Therefore, it is possible to reduce differences in apparent dimensions viewed from the sensor device 5, between a three-dimensional marker 60 in a group relatively closer to the sensor device 5 and a three-dimensional marker 60 in a group relatively further from the sensor device 5. Accordingly, it is possible to reduce differences between the apparent sizes of the three-dimensional marker 60 in the two-dimensional image outputted from the sensor device 5. Alternatively, the three-dimensional markers 60 with the same size may be placed at different distances from the sensor device 5. In this case, there may be advantageous effects that there is no need to prepare different types of three-dimensional markers 60 with different sizes.

(2.2.2) Explanation of Operation in Cooking Assisting Mode

The interactive interface system 1 of the present embodiment is used in a kitchen assistance system. Hereinafter, operation where the kitchen assistance system assists kitchen work of the worker H1 is described. The kitchen assistance system may be used in a kitchen such as a cooking place in a fast-food restaurant to assist cooking work performed by a worker (cook), for example. The kitchen assistance system of the present embodiment is for assisting cooking work for preparing hamburgers, for example. The cooking work for hamburgers includes a plurality of steps. The kitchen assistance system projects the cooking instruction screen indicating operation performed by the worker H1 in each of the plurality of steps, from the projection device 2 onto the work surface 101 of the cooking counter 100.

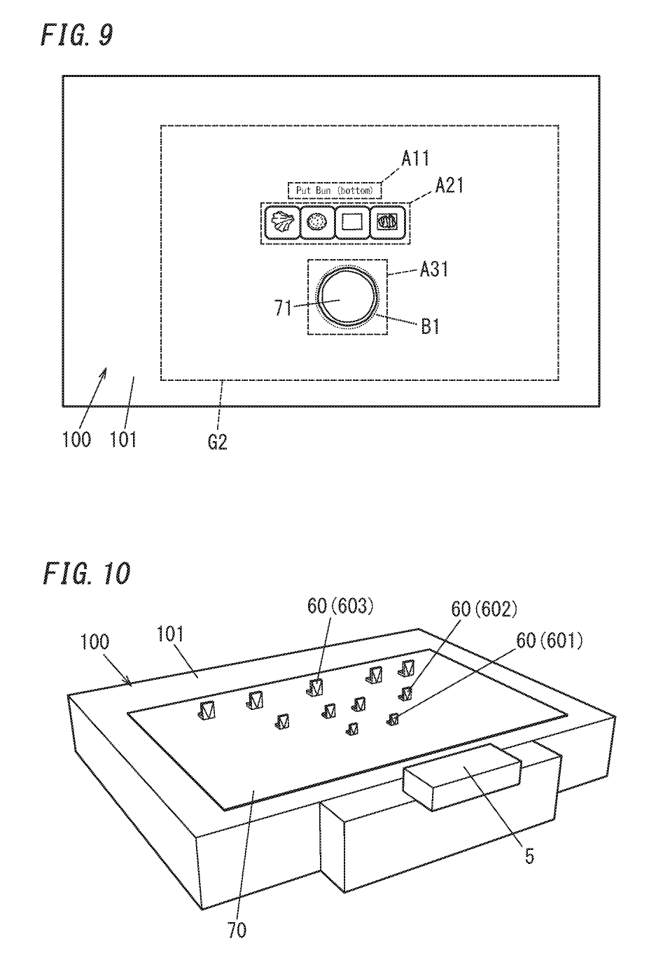

FIG. 9 shows one example of the cooking instruction screen G2 projected onto the work surface 101 of the cooking counter 100. In the example shown in FIG. 9, the cooking instruction screen G2 contains a display area A11 for displaying texts or the like indicating the work procedure, a display area A21 displaying foodstuffs used in preparation by photographs or the like, and a display area A31 displaying the working procedure by illustrative drawings or the like. The display area A11 shows a text “Place sliced bun (bottom)” as the texts indicating the work procedure. The display area A31 shows a pictorial symbol B1 representing the bottom sliced bun.

When the worker H1 places a bottom sliced bun 71 above the pictorial symbol B1 displayed on the display area A31 of the cooking instruction screen G2, the sensor device 5 detects a position of the sliced bun 71 placed on the work surface 101. In more detail, the sensor device 5 outputs the two-dimensional image and the distance image representing the work area 110, to the controller 3. For example, the position obtainment unit 32 performs pattern matching to detect the sliced bun 71 from the two-dimensional image inputted from the sensor device 5. Thereafter, the position obtainment unit 32 obtains the position of the sliced bun 71 in the work surface 101, based on the position of the sliced bun 71 in the two-dimensional image and the distance from the sensor device 5 to the sliced bun 71 calculated from the distance image. Note that, performing such a pattern matching process is not necessary in determining the position of the sliced bun 71. The position of the sliced bun 71 may be determined based on the distance calculated from the distance image. When the position obtainment unit 32 obtains the detection position of the sliced bun 71 in the work surface 101, the detection position of the sliced bun 71 is corrected by use of the correction information stored in the storage device 4 and thereby the correct position of the sliced bun 71 is obtained. Therefore, an error of the detection position can be reduced.

Note that, the storage device 4 stores the correction information for each of a plurality of predetermined places (the positions of the dots D1 to D11) in the display screen (the work surface 101) of the projection device 2. The controller 3 can determine the correction information for positions other than the plurality of predetermined places (the positions of the dots D1 to D11) by interpolation by use of the correction information for the predetermined places. Accordingly, there may be no need to directly determine the correction information for all the positions in the display screen. Further, for the positions other than the plurality of predetermined places (the positions of the dots D1 to D11), the controller 3 can correct the detection position by use of the correction information determined by the interpolation. Therefore, it is possible to determine positions of objects more accurately.

When determining the position of the sliced bun 71 placed on the work surface 101, the controller 3 projects images (pictures) of foodstuffs (e.g., meat patties) to be placed on the sliced bun 71, onto the sliced bun 71, based on the detection position of the sliced bun 71. Consequently, the worker H1 performing the cooking work can easily understand next operation based on the image projected onto the sliced bun 71. Thus, the kitchen assistance system can assist the cooking work performed by the worker H1. Further, since the present embodiment can detect positions of objects placed on the work surface 101 accurately, it is possible to project images onto the objects placed on the work surface 101 accurately. Additionally, for example, the controller 3 can projects images or pictures of the display areas A11 and A21 of the cooking instruction screen G2 onto a place where no object exists. Therefore, visibility of the display areas A11 and A21 can be improved.

(3) Variations

The above embodiment may be only one of various embodiments according to the present disclosure. The above embodiment may be modified in various ways in accordance with design or the like, as long as they can achieve the purpose of the present disclosure. Note that, a function equivalent to the interactive interface system 1, the work assistance system or the kitchen assistance system may be realized by the calibration method for the interactive interface system 1, a computer program, a program recorded non-transitive recording medium, or the like. The calibration method for the interactive interface system 1 of one aspect includes a displaying step (step S2 in FIG. 4), a detecting step (step S4 in FIG. 4), and an adjusting step (S5 in FIG. 4). The displaying step is a step of displaying, by the display device (the projection device 2), a picture on the display screen. The detecting step is a step of detecting, by the sensor device 5, the position of the marker (the three-dimensional marker 60) present within the display screen. The adjusting step is a step of performing calibration between the display position on the display screen and the detection position by the sensor device 5, based on the detection result given by the sensor device 5. The (computer) program of one aspect is a program enabling a computer system to execute the displaying step, the detecting step, and the adjusting step.

Hereinafter, variations of the above embodiment are listed. The variations described below may be applicable in appropriate combination.

The interactive interface system 1, the work assistance system, the kitchen assistance system, or one or more entities implementing the calibration method in the present disclosure include a computer system. The computer system includes main hardware components including one or more processors and one or more memories. The one or more processors execute one or more programs recorded in the one or more memories of the computer system, thereby functioning as the interactive interface system 1, the work assistance system, the kitchen assistance system, or one or more entities implementing the calibration method in the present disclosure. Such one or more programs may be stored in the one or more memories of the computer system in advance, or may be provided through telecommunication circuits, or may be provided with being recorded in one or more non-transitive recording media readable by computer systems. Examples of the non-transitive recording media readable by computer systems may include memory cards, optical disks, and hard disk drive. A processor of such a computer system may include one or more electronic circuits including a semiconductor integrated circuit (IC) or a large scale integrated circuit (LSI). The electronic circuits may be aggregated into one chip, or distributed to chips. The chips may be aggregated into one device, or distributed to devices.

The interactive interface system 1 includes the controller 3, the sensor device 5, and the projection device 2. Alternatively, the interactive interface system 1 can be realized by a single device where components are accommodated in a single case.

As to the above embodiment, in the calibration mode, the calibration is executed in a condition where the eleven three-dimensional markers 60 are arranged on the display screen. However, the number of three-dimensional markers 60 may be one or two or more and may be changed appropriately. Note that, to form a plane based on the detection positions of the three-dimensional markers 60, at least three three-dimensional markers 60 are required. However, when a size or shape of a plane to be adjusted is determined in advance, it is enough to provide one or more reference points. In such a case, the number of three-dimensional markers 60 may be one or more. Note that, the arrangement of the three-dimensional markers 60 shown in FIG. 5 is a mere example, and the arrangement of the plurality of three-dimensional markers 60 may be modified appropriately.

Alternatively, as shown in FIG. 10, the plurality of three-dimensional markers 60 may be formed as one part. In more detail, the plurality of three-dimensional markers 60 may be fixed to a plate member 70 with a flat plate shape to be placed on the work surface 101. In this case, the adjustment screen G1 may show the dots D1 to D11 indicating the positions of the plurality of three-dimensional markers 60 or a frame line for positioning the plate member 70. Since the plurality of three-dimensional markers 60 are formed integrally with the plate member 70, arrangement of the plurality of three-dimensional markers 60 can be facilitated.

In the above embodiment, the marker is the three-dimensional marker 60 placed on the predetermined place overlapping the display screen. However, the marker may not be limited to the three-dimensional marker 60. The marker may be modified appropriately as long as the sensor device 5 can detect it. When the sensor device 5 includes the infrared camera 52, it is sufficient that the marker is detectable by the infrared camera 52. Examples of the marker may include a light source for emitting infrared light in the area of the display screen, a reflective member for reflecting infrared light in the area of the display screen, a scattering member for scattering infrared light in the area of the display screen, and a light spot displayed in the display screen.

In the above embodiment, since the display device includes the projection device 2, the projection device 2 can project an image onto a desired position of the work surface 101. Note that, the display device may not be limited to the projection device 2 but may be a flat screen display embedded in the work surface 101 of the cooking counter 100. Examples of such a display may include a liquid crystal display and an organic EL (Electro Luminescence) display.

Alternatively, one or some of images displayed by the projection device 2 other than the adjustment screen G1 may be displayed by an additional device other than the projection device 2. Examples of the additional device may include a liquid display device and a tablet terminal which are placed in a vicinity of the work area 110.

Note that, in the above embodiment, a function of at least one of the position obtainment unit 32 and the detection position adjustment unit 33 included in the controller 3 of the interactive interface system 1 may be distributed to two or more systems. Or, individual functions of the position obtainment unit 32 and the detection position adjustment unit 33 may be distributed to a plurality of devices. Alternatively, one or more of functions of the interactive interface system 1 may be implemented by the cloud (cloud computing), for example.

The infrared irradiator 51 of the sensor device 5 of the present embodiment irradiates a whole of a distance measurement region with infrared light, and the infrared camera 52 receives a plane of light reflected from objects. However, the infrared irradiator 51 may sweep the distance measurement region with infrared light by changing a direction of irradiation of the infrared light. In this case, the infrared camera 52 receives a point of light reflected from objects. Note that, the infrared irradiator 51 may be optional for the interactive interface system 1. If the infrared camera 52 can take images based on natural light or illumination light, the infrared irradiator 51 may be omitted appropriately.

The infrared irradiator 51 and the infrared camera 52 of the sensor device 5 are used to measure distances to objects by the TOF method. However, such distances to objects can be measured by a pattern projection method (light coding method) or a stereo camera. Note that, the infrared camera 52 can be replaced with a combination of a CMOS image sensor or a CCD image sensor and an infrared transmission filter.

The sensor device 5 measures distances to objects by use of infrared light with the infrared irradiator 51 and the infrared camera 52, but may measure distances to objects by an ultrasonic wave, a radio wave, or the like.

The kitchen assistance system including the interactive interface system 1 of the above embodiment is used in a kitchen of a fast-food restaurant. However, the kitchen assistance system may be used in a kitchen of a restaurant, a hotel, or the like. Alternatively, the kitchen assistance system including the interactive interface system 1 may be used in a cooking place for prepared foods in a backyard of a supermarket, a food processing plant, or the like. Or, the interactive interface system 1 of the above embodiment may be included in a work assistance system for assisting cooking work in an ordinary home.

Or, the interactive interface system 1 of the above embodiment may be included in a work assistance system for assisting work other than the cooking work, and the projection device 2 may display a picture for assisting such work on the display screen. Examples of such a work assistance system may include systems for assisting work including a plurality of steps in a factory or the like, such as assembling work of assembling a target object, disassembling work of disassembling a target object, cleaning work of cleaning a target object, and maintenance work of maintaining an object.

Alternatively, the interactive interface system 1 of the present embodiment may not be limited to being included in a work assistance system for assisting some work, but may be used as an interface system for any system.

(Aspects)

As described above, a first aspect is an interactive interface system (1) including: a display device (2) configured to display a picture on a display screen; and a sensor device (5) configured to detect a position of a detection target. The interactive interface system (1) has a calibration mode. The calibration mode is a mode of performing calibration between a display position on the display screen (101) and a detection position by the sensor device (5), based on a detection result which is given by the sensor device (5) and indicates a detected position of a marker (60, 601 to 603) present within the display screen (101).

According to this aspect, the calibration mode preforms calibration between the display position on the display screen (101) and the detection position of the marker (60, 601 to 603) detected by the sensor device (5). Thus, the calibration can be conducted in a condition where a body or clothes of the user does not present near the position of the marker or the display position on the display screen (101). Consequently, the body or clothes of the user can be suppressed from influencing on the calibration result and thus the accuracy of the calibration can be improved.

A second aspect is based on the interactive interface system (1) according to the first aspect, wherein the sensor device (5) is configured to detect the detection target in a direction across a direction perpendicular to the display screen (101).

According to this aspect, it is possible to determine whether or not the object is in contact with the display screen (101).

A third aspect is based on the interactive interface system (1) according to the first or second aspect, wherein the display device (2) includes a projection device (2) configured to project a picture onto the display screen (101).

According to this aspect, it is possible to project a picture onto a predetermined place in the display screen (101).

A fourth aspect is based on the interactive interface system (1) according to any one of the first to third aspects, wherein the marker (60, 601 to 603) is a three-dimensional marker placed at a predetermined place overlapping the display screen (101).

According to this aspect, the calibration can be conducted in a condition where a body or clothes of the user does not present near the position of the three-dimensional marker (60, 601 to 603) or the display position on the display screen (101). Consequently, the body or clothes of the user can be suppressed from influencing on the calibration result and thus the accuracy of the calibration can be improved.

A fifth aspect is based on the interactive interface system (1) according to the fourth aspect, wherein: the sensor device (5) includes an image sensor (52, 53) configured to take an image of a imaging area (110) including the display screen (101); and the three-dimensional marker (60, 601 to 603) includes a display part (62) indicative of a contact point with the display screen (101).

According to this aspect, the sensor device (5) can detect the contact point indicated by the display part (62). Therefore, calibration between the display position on the display screen (101) and the contact point can be performed.

A sixth aspect is based on the interactive interface system (1) according to the fourth or fifth aspect, wherein: a plurality of the three-dimensional markers (60, 601 to 603) are placed at a plurality of the predetermined places overlapping the display screen (101); and the plurality of three-dimensional markers (60, 601 to 603) are formed as one part.

According to this aspect, it is possible to facilitate arrangement of the plurality of three-dimensional markers (60, 601 to 603).

A seventh aspect is based on the interactive interface system (1) according to any one of the fourth to sixth aspects, wherein: a plurality of the three-dimensional markers (60, 601 to 603) are placed at a plurality of the predetermined places overlapping the display screen (101); and the plurality of three-dimensional markers (60, 601 to 603) include two or more three-dimensional markers (60, 601 to 603) which are placed at different distances from the sensor device (5) and have mutually different actual sizes to reduce an apparent dimensional difference therebetween when viewed from the sensor device (5).

According to this aspect, it is possible to reduce differences in apparent dimensions viewed from the sensor device (5) between the plurality of three-dimensional markers (60, 601 to 603).

An eighth aspect is based on the interactive interface system (1) according to any one of the fourth to seventh aspects, wherein a plurality of the three-dimensional markers (60, 601 to 603) are arranged not to allow at least one parts thereof to overlap with each other when viewed from the sensor device (5).

According to this aspect, the sensor device (5) can detect the positions of the plurality of three-dimensional markers (60, 601 to 603) at one time.

A ninth aspect is based on the interactive interface system (1) according to any one of the first to eighth aspects, wherein the sensor device (5) is placed in one direction when viewed from the display screen (101).

According to this aspect, it is possible to detect the position of the object overlapping the display screen (101) by use of the sensor device (5) placed in one direction when viewed from the display screen (101).

Note that, Note that, configurations according to the second to ninth aspects are optional for the interactive interface system (1), and may be omitted appropriately.

A tenth aspect is a work assistance system including the interactive interface system (1) according to any one of the first to ninth aspects, wherein the display device (2) is configured to display an item for assisting work on the display screen (101).

Accordingly, this aspect enables provision of the work assistance system capable of improving accuracy of the calibration.

An eleventh aspect is a kitchen assistance system including the interactive interface system (1) according to any one of the first to ninth aspects, wherein the display device (2) is configured to display an item for assisting cooking work in a kitchen on the display screen (101).

Accordingly, this aspect enables provision of the kitchen assistance system capable of improving accuracy of the calibration.

A twelfth aspect is an interactive interface system calibration method including: a displaying step, a detecting step, and an adjusting step. The displaying step is a step of displaying, by a display device (2), a picture on a display screen (101). The detecting step is a step of detecting, by a sensor device (5), a position of a marker (60, 601 to 603) present within the display screen (101). The adjusting step is a step of performing calibration between a display position on the display screen (101) and a detection position by the sensor device (5), based on a detection result given by the sensor device (5).

Accordingly, this aspect enables improvement of accuracy of the calibration.

A thirteenth aspect is based on the interactive interface system (1) according to any one of the first to ninth aspects, wherein the display device (2) is configured to display a position where the three-dimensional marker (60, 601 to 603) is to be placed, on the display screen (101).

A fourteenth aspect is based on the interactive interface system (1) according to the fourth aspect, wherein the display device (2) is configured to display a position where the three-dimensional marker (60, 601 to 603) is to be placed, on the display screen (101).

A fifteenth aspect is based on the work assistance system according to the tenth aspect, wherein the display screen is included in a work surface (101) for the work.

A sixteenth aspect is based on the kitchen assistance system according to the eleventh aspect, wherein the display screen is included in a work surface (101) for the cooking work.

1. An interactive interface system comprising:
a display device configured to display a picture on a display screen; and
a sensor device configured to detect a position of a detection target,
the interactive interface system further comprising a calibration mode of performing calibration between a display position on the display screen and a detection position by the sensor device, based on a detection result which is given by the sensor device and indicates a detected position of a marker present within the display screen.

2. The interactive interface system according to claim 1, wherein
the sensor device is configured to detect the detection target in a direction across a direction perpendicular to the display screen.

3. The interactive interface system according to claim 1, wherein
the display device includes a projection device configured to project a picture onto the display screen.

4. The interactive interface system according to claim 2, wherein
the display device includes a projection device configured to project a picture onto the display screen.

5. The interactive interface system according to claim 1, wherein
the marker is a three-dimensional marker placed at a predetermined place overlapping the display screen.

6. The interactive interface system according to claim 2, wherein
the marker is a three-dimensional marker placed at a predetermined place overlapping the display screen.

7. The interactive interface system according to claim 3, wherein
the marker is a three-dimensional marker placed at a predetermined place overlapping the display screen.

8. The interactive interface system according to claim 4, wherein
the marker is a three-dimensional marker placed at a predetermined place overlapping the display screen.

9. The interactive interface system according to claim 5, wherein:
the sensor device includes an image sensor configured to take an image of a imaging area including the display screen; and
the three-dimensional marker includes a display part indicative of a contact point with the display screen.

10. The interactive interface system according to claim 5, wherein:
a plurality of the three-dimensional markers are placed at a plurality of the predetermined places overlapping the display screen; and
the plurality of three-dimensional markers are formed as one part.

11. The interactive interface system according to claim 5, wherein:
a plurality of the three-dimensional markers are placed at a plurality of the predetermined places overlapping the display screen; and
the plurality of three-dimensional markers include two or more three-dimensional markers which are placed at different distances from the sensor device and have mutually different actual sizes to reduce an apparent dimensional difference therebetween when viewed from the sensor device.

12. The interactive interface system according to claim 5, wherein
a plurality of the three-dimensional markers are arranged not to allow at least one parts thereof to overlap with each other when viewed from the sensor device.

13. The interactive interface system according to claim 6, wherein
a plurality of the three-dimensional markers are arranged not to allow at least one parts thereof to overlap with each other when viewed from the sensor device.

14. The interactive interface system according to claim 1, wherein
the sensor device is placed in one direction when viewed from the display screen.

15. The interactive interface system according to claim 5, wherein
the display device is configured to display a position where the three-dimensional marker is to be placed, on the display screen.

16. A work assistance system comprising: the interactive interface system according to claim 1, the display device being configured to display an item for assisting work on the display screen.

17. The work assistance system according to claim 16, wherein
the display screen is included in a work surface for the work.

18. A kitchen assistance system comprising: the interactive interface system according to claim 1, the display device being configured to display an item for assisting cooking work in a kitchen on the display screen.

19. The kitchen assistance system according to claim 18, wherein
the display screen is included in a work surface for the cooking work.

20. An interactive interface system calibration method comprising:
a displaying step of displaying, by a display device, a picture on a display screen;
a detecting step of detecting, by a sensor device, a position of a marker present within the display screen; and
an adjusting step of performing calibration between a display position on the display screen and a detection position by the sensor device, based on a detection result given by the sensor device.
